(19) United States
(12) Patent Application Publication
(10) Pub. No.: US 2011/0136518 A1
(43) Pub. Date: Jun. 9, 2011

(54) COMMUNICATION APPARATUS, COMMUNICATION METHOD, AND COMPUTER PROGRAM PRODUCT FOR A WIRELESS COMMUNICATION SYSTEM

(75) Inventors: Hsien-Tsung HSU, Taoyuan City (TW); Tsung-Yu TSAI, Shanhua Town (TW); Yi-Ting LIN, Yonghe City (TW)

(73) Assignee: INSTITUTE FOR INFORMATION INDUSTRY, Taipei (TW)

(21) Appl. No.: 12/631,650

(22) Filed: Dec. 4, 2009

(51) Int. Cl. H04W 4/12

(52) U.S. Cl. 455/466

(57) ABSTRACT

A communication apparatus, a communication method, and a computer program product for a wireless communication system are provided. The communication apparatus comprises a receive module, a process module, and a transmit module. The receive module is configured to receive a first request message transmitted from a first mobile apparatus with at least one first sequence and to receive a second request message transmitted from a second mobile apparatus with at least one second sequence. The processing module is configured to determine whether the at least one first sequence is the same as the at least one second sequence. The transmission module is configured to transmit a response message according to the determination result. Finally, the first and second mobile apparatuses determine whether to transmit a first and second data according to the response message, respectively.

### FIELD

The present invention relates to a communication apparatus, a communication method, and a computer program product thereof for a wireless communication system; more particularly, the present invention relates to a communication apparatus, a communication method, and a computer program product thereof for an orthogonal frequency division multiple access (OFDMA) wireless communication system.

### BACKGROUND

With widespread use of wireless communication in recent years, mobile communication apparatuses held by the general public are becoming increasing in both variety and quantity. However, the mobile communication apparatuses currently available in the market, such as those adopting GSM (Global System for Mobile Communications), WCDMA (Wideband Code Division Multiple Access), GPRS (General Packet Radio Service), PHS (General Packet Radio Service), WiFi (Wireless Fidelity), WiMAX (Worldwide Interoperability for Microwave Access) or LTE (Long Term Evolution) all rely on a base station to provide wireless voice, image, data communication and mobile apparatus positioning services.

Recently, owing to the considerably heightened demands on bandwidth of wireless networks, the WiMAX (also known as IEEE 802.16) standard based on the Internet Protocol (IP) and the LTE technology based on GSM have become a focus of development for wireless communication network providers and wireless communication apparatus manufacturers. Both the WiMAX standard and the LTE technology are wireless transmission specifications that adopt a transmission mode of Orthogonal Frequency Division Multiplexing (OFDM)/Orthogonal Frequency Division Multiplexing Access (OFDMA).

More specifically, as a wireless transmission mode that incorporates Time Division Multiplexing (TDM) and Frequency Division Multiplexing (FDM) together, OFDM/OFDMA utilizes different subcarriers to provide data transmission for different users or to transmit data for different purposes.

In order to decrease the dead zone of communication, improve the system capacity and make more efficient use of the wireless bandwidth resources of the wireless communication system, increasingly more concerns have been put on femtocell BSs in addition to the original deployment of macro BSs. The femtocell BS technology has been considered as one of the key technologies for the next generation of wireless communication. On the other hand, both the WiMAX standard and the LTE technology are expected to support the femtocell BS technology.

Since wireless communication is accomplished by transmitting messages through radio waves in the air, the communication environment is rather complex and liable to interference. Moreover, when two wireless communication systems of different kinds (e.g., one adopts the WiMAX standard and the other adopts the LTE technology) are deployed with an increased number of BSs to cause too close distances among the individual BSs, it is highly possible that the two wireless communication systems will interfere with each other's signals to cause degradation in communication quality. Besides, the high deployment density of the BSs further makes it much more difficult to allocate the wireless bandwidth resources and decreases the overall utilization efficiency of the wireless bandwidth resources of the wireless communication system.

On the other hand, since the femtocell BS is used to establish wireless communication within a small range, the number and deployment density of the BSs will be increased greatly. Moreover, the femtocell BSs are often deployed by users and use a wired network as a medium for its backhaul data transmission, so there lacks a medium that allows quick data transmission among the BSs for connection and control purpose. All these make interference management and power control of the femtocell BSs much more difficult.

Accordingly, there remains a need to provide a solution that can mitigate or obviate interferences of individual BSs or femtocell BSs with each other due to too close distances therebetween without modifying the hardware architecture of the existing wireless communication system and, meanwhile, can also take the overall spectrum efficiency, data transmission speed and computational burden of the wireless communication system into account.

### SUMMARY

An objective of certain embodiments of the present invention is to provide a communication apparatus for a wireless communication system. The wireless communication system comprises a server apparatus, a base station (BS) and a plurality of mobile apparatuses. The mobile apparatuses comprise a first mobile apparatus with a first datum and a second mobile apparatus with a second datum. The server apparatus is electrically connected to the communication apparatus and the BS. The first mobile apparatus is wirelessly connected to the communication apparatus. The second mobile apparatus is wirelessly connected to the BS. Both the first and second mobile apparatuses are located within a wireless communication coverage of the communication apparatus and a wireless communication coverage of the BS.

The communication apparatus comprises a receive module, a process module and a transmit module. The receive module is configured to receive a mode transformation message which is transmitted by the server apparatus according to a usage amount of wireless bandwidth resources of the wireless communication system. The process module is configured to switch the communication apparatus from a controlled mode to an uncontrolled mode according to the mode transformation message. The receive module is further configured to receive a first request message transmitted by the first mobile apparatus with at least one first sequence and to receive a second request message transmitted by the second mobile apparatus with at least one second sequence. The process module is further configured to determine whether the at least one first sequence and the at least one second sequence are identical to a same sub-block. The transmit module is configured to transmit a response message according to the determination result of the process module. Finally, the first mobile apparatus determines whether to transmit the first datum according to the response message.

Another objective of certain embodiments of the present invention is to provide a communication method for the aforesaid wireless communication system. The communication method comprises the steps of: enabling a receive module to receive a mode transformation message which is transmitted by the server apparatus according to a usage amount of wireless bandwidth resources of the wireless communication system; enabling a process module to switch the communication apparatus from a controlled mode to an uncontrolled mode according to the mode transformation message; enabling the receive module to receive a first request message transmitted by the first mobile apparatus with at least one first sequence; enabling the receive module to receive a second request message transmitted by the second mobile apparatus with at least one second sequence; enabling the process module to determine whether the at least one first sequence and the at least one second sequence are identical to a same sub-block; and enabling a transmit module to transmit a response message according to the determination result of the process module. Finally, the first mobile apparatus determines whether to transmit the first datum according to the response message.

To accomplish the aforesaid objectives, certain embodiments of the present invention further provide a computer program product comprising a tangible machine-readable medium which has executable codes to perform the aforesaid communication method. When the executable codes are loaded into the communication apparatus via a computer and executed, the aforesaid communication method can be accomplished.

The communication apparatus, the communication method and the computer program product thereof of certain embodiments of the present invention are able to allocate wireless bandwidth resources of the wireless communication system according to request messages from individual mobile apparatuses, and reallocate the wireless bandwidth resources in consideration of a potential conflict, thereby mitigating signal interference among the BSs in the wireless communication system. In this way, the problem that BSs of two kinds of communication systems interfere with each other's signals when the BSs have a too close distance or a too high density can be addressed without modifying the existing hardware architecture of the wireless communication system.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIGS. 1A-1G are schematic diagrams illustrating a first embodiment of the present invention;

FIGS. 2A-2B are flowcharts of a communication method of a second embodiment of the present invention;

FIG. 3 is a flowchart of a communication method of a third embodiment of the present invention; and

FIG. 4 is a flowchart of a server method of a fourth embodiment of the present invention.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the spirit and scope of the invention as defined by the appended claims.

### DETAILED DESCRIPTION

In the following description, certain embodiments of the present invention will be explained with reference to example embodiments thereof. The present invention relates to a communication apparatus for a wireless communication system and a communication method thereof. The wireless communication system may be, for example, a WiMAX or an LTE wireless communication system that adopts an OFDM/OFDMA transmission mode. However, description of these embodiments is only for purpose of illustration rather than to limit the present invention. It should be noted that elements unrelated to the present invention are omitted from depiction in the following embodiments and the attached drawings; and dimensional relationships among individual elements in the attached drawings are illustrated only for ease of understanding, not to limit the actual scale.

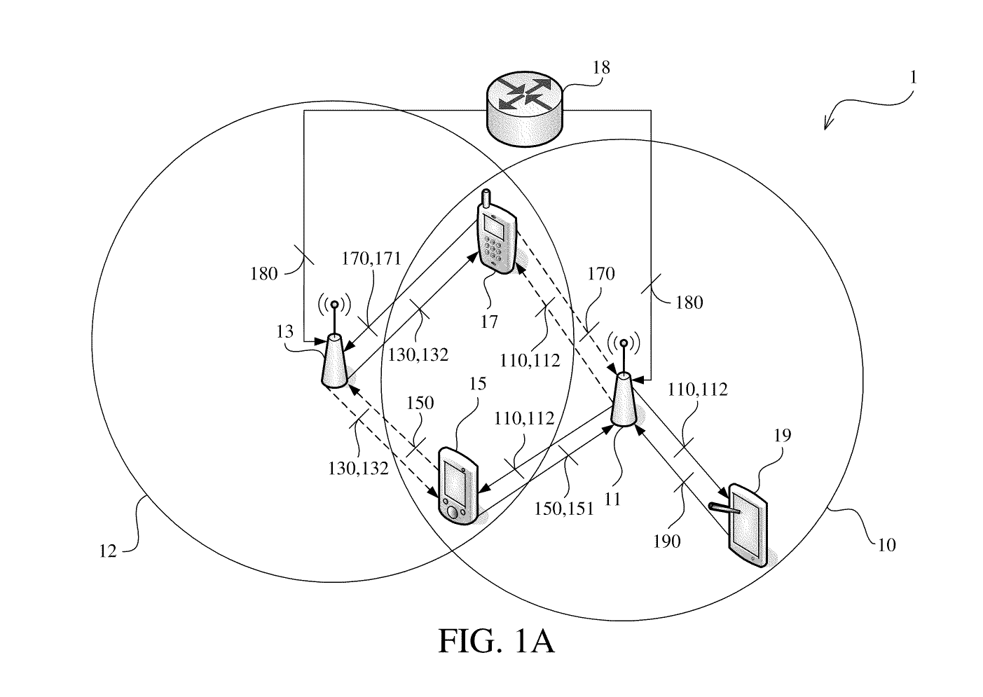

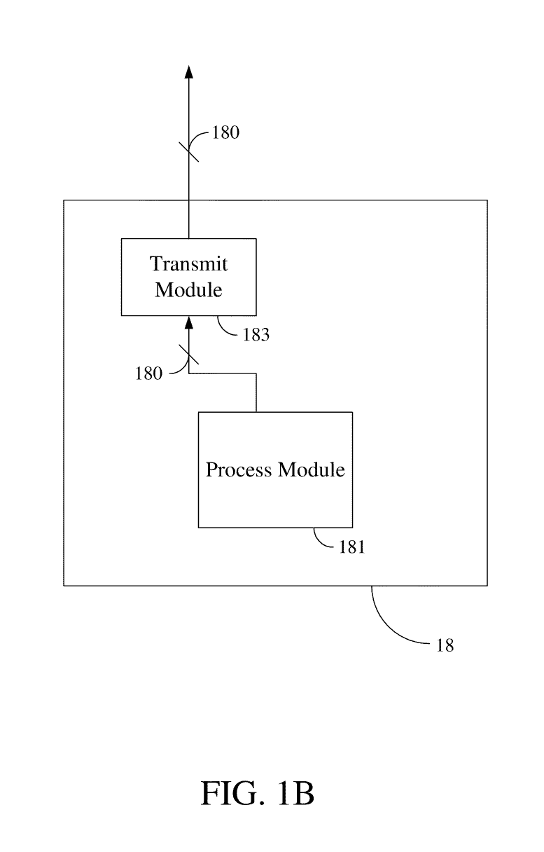

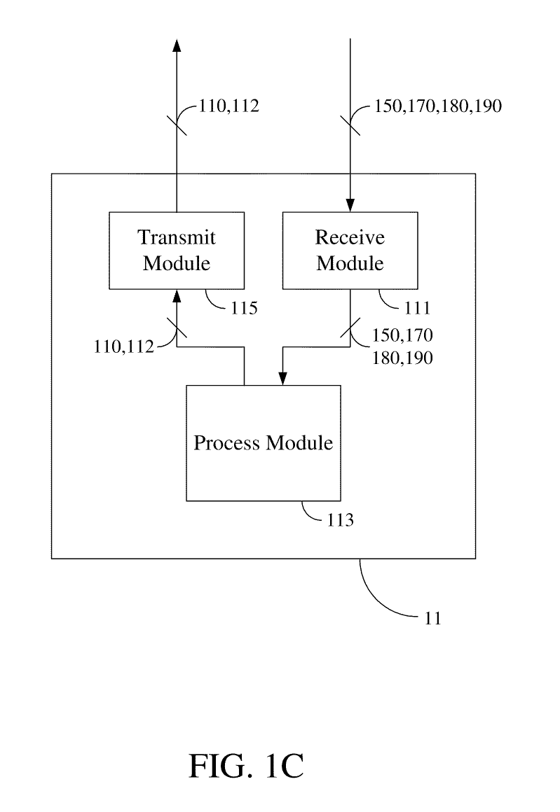

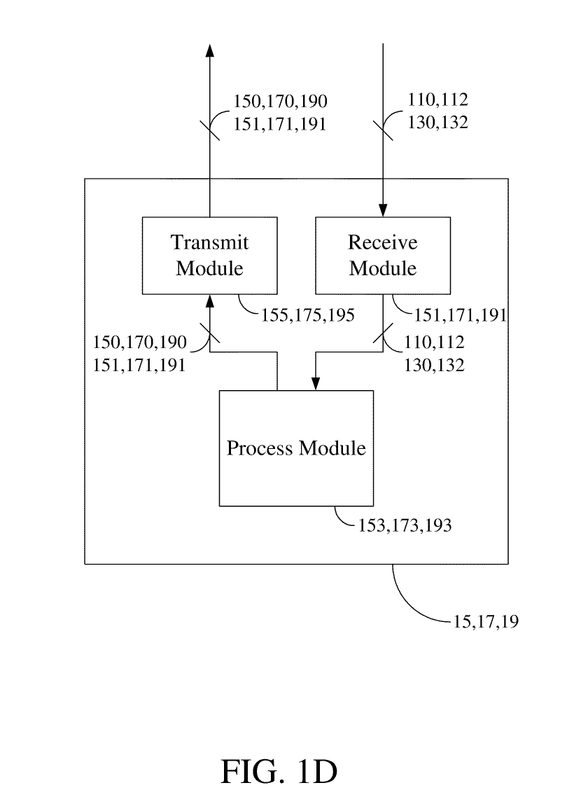

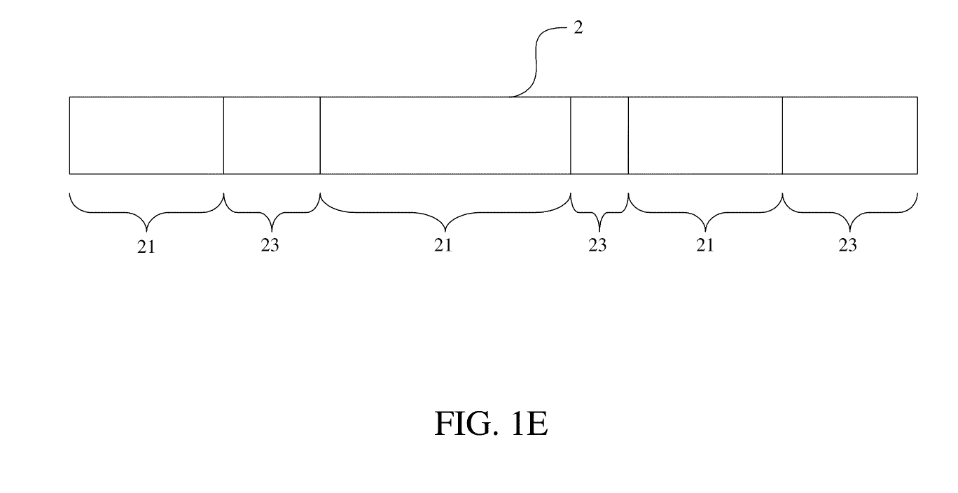

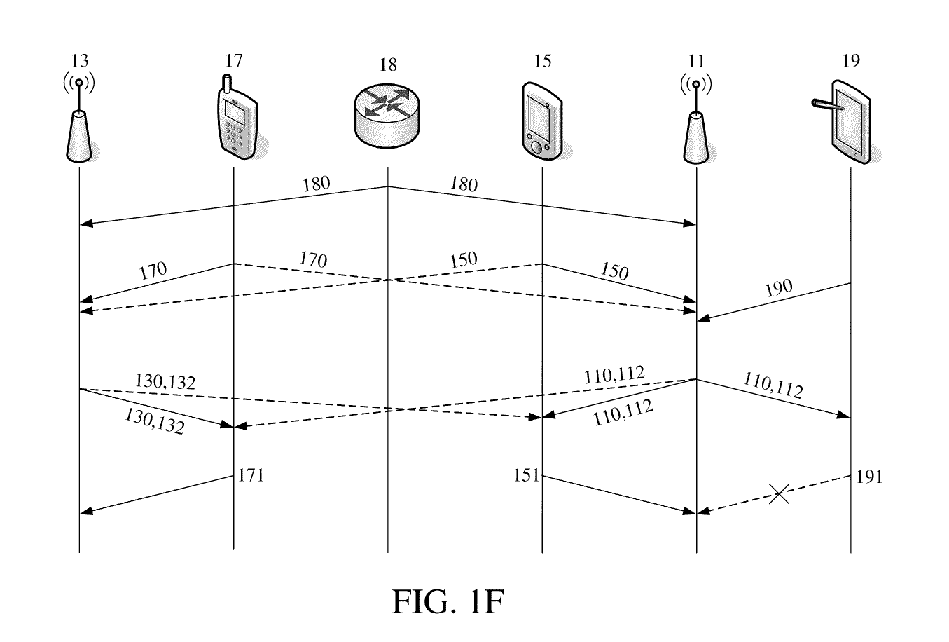

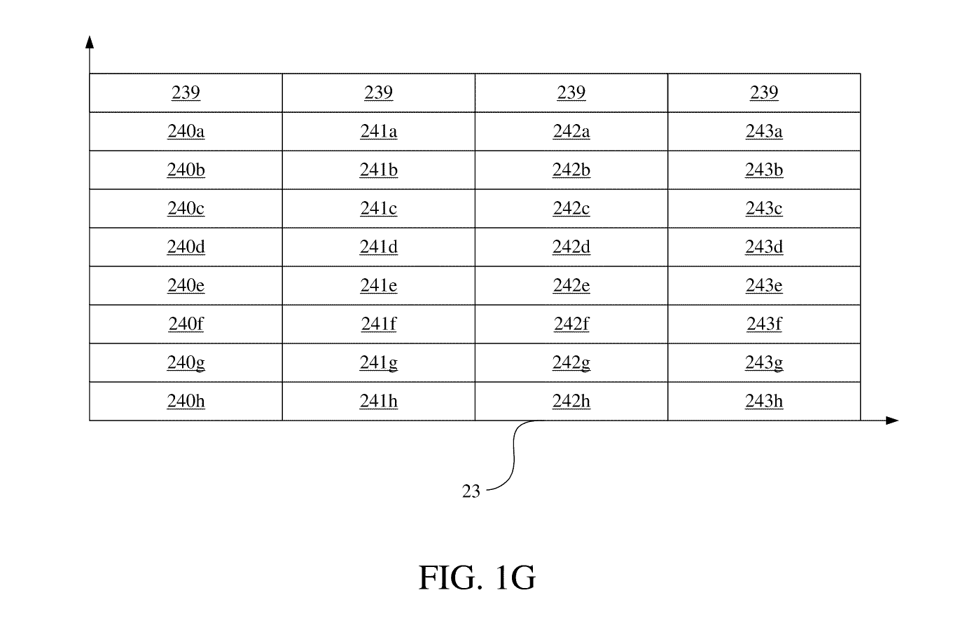

Hereinafter, a first example embodiment will be described with reference to schematic views depicted in FIGS. 1A-1G. In particular, FIG. 1A is a schematic view of a wireless communication system 1. The wireless communication system 1 comprises a plurality of communication apparatuses 11, 13, a plurality of mobile apparatuses 15, 17, 19 and a server apparatus 18. It should be noted that, the communication apparatuses 11, 13 may be macro BSs and/or femtocell BSs. The server apparatuses 18 may be a server and/or a router capable of allocating wireless bandwidth resources 2 of the wireless communication system 1. For purpose of simplicity, the communication apparatus 11 and the BS 13 will be described as examples thereof in this embodiment. The mobile apparatuses 15, 17, 19 may be smart mobile phones, personal digital assistants (PDAs) or netbooks with wireless communication functionality. For purpose of simplicity, a first mobile apparatus 15, a second mobile apparatus 17 and a third mobile apparatus 19 will be described as examples thereof in this embodiment.

As described above, the communication apparatus 11 has first wireless communication coverage 10, and the BS 13 has second wireless communication coverage 12. Additionally, both the communication apparatus 11 and the BS 13 are electrically connected to the server apparatus 18. It should be noted that the present invention has no limitation on how the communication apparatus 11 and the BS 13 are electrically connected to the server apparatus 18, and people of ordinary skill in the art may electrically connect the communication apparatus 11, the BS 13 and the server apparatus 18 in a wireless/wired manner, and this will not be further described herein.

In this example embodiment, the communication apparatus 11 and the BS 13 are located within a close distance of each other so that the first wireless communication coverage 10 and the second wireless communication coverage 12 are partially overlapped. Both the first mobile apparatus 15 and the second mobile apparatus 17 are located within the first wireless communication coverage 10 and the second wireless communication coverage 12 simultaneously; and the third mobile apparatus 19 is located within the first wireless communication coverage 10. It should be noted that the first mobile apparatus 15 and the third mobile apparatus 19 are wirelessly connected to the communication apparatus 11, and the second mobile apparatus 17 is wirelessly connected to the BS 13.

As shown in FIG. 1B, the server apparatus 18 of the first example embodiment comprises a process module 181 and a transmit module 183. The transmit module 183 is electrically connected to the process module 181. More specifically, in the wireless communication system 1, the server apparatus 18 allocates the wireless bandwidth resources 2 of the wireless communication system 1 to the communication apparatus 11 and the BS 13 to which it is electrically connected.

Further speaking, as shown in FIG. 1C, the communication apparatus 11 of the first embodiment comprises a receive module 111, a process module 113 and a transmit module 115. The receive module 111 and the transmit module 115 are electrically connected to the process module 113 individually. More specifically, in the wireless communication system 1, the communication apparatus 11 communicates with the first mobile apparatus 15 and the third mobile apparatus 19 to which it is wirelessly connected according to the wireless bandwidth resources 2 of the wireless communication system 1 allocated by the server apparatus 18, and the BS 13 communicates with the second mobile apparatus 17 to which it is wirelessly connected according to the wireless bandwidth resources 2 of the wireless communication system 1 allocated by the server apparatus 18.

Meanwhile, as shown in FIG. 1D, the mobile apparatuses 15, 17, 19 of the first example embodiment comprises a receive module 151, 171, 191, a process module 153, 173, 193 and a transmit module 155, 175, 195, respectively. The receive modules 151, 171, 191 and the transmit modules 155, 175, 195 are electrically connected to the process module 153, 173, 193, respectively. People of ordinary skill in the art may readily know how the server apparatus 18, the communication apparatus 11, the BS 13 and the mobile apparatuses 15, 17, 19 execute the related operations and functions based on the following description.

The wireless bandwidth resources 2 of the wireless communication system 1 are as shown in FIG. 1E. During operation of the wireless communication system 1, the process module 181 of the server apparatus 18 will allocate the wireless bandwidth resources 2 according to a usage amount of the wireless bandwidth resources 2. More specifically, the process module 181 of the server apparatus 18 will generate a mode transformation message 180 according to the usage amount of the wireless bandwidth resources 2. Then the transmit module 183 of the server apparatus 18 transmits the mode transformation message 180 to the communication apparatus 11 and the BS 13. The communication apparatus 11 and the BS 13 will be switched between a controlled mode and an uncontrolled mode after receiving the mode transformation message 180.

Further speaking, when the communication apparatus 11 and the BS 13 operate in the controlled mode, the process module 181 of the server apparatus 18 will allocate the controlled wireless bandwidth resources 21 of the wireless bandwidth resources 2 to the communication apparatus 11 and the BS 13 for data transmission. On the other hand, when the communication apparatus 11 and the BS 13 operate in an uncontrolled mode, the process module 181 of the server apparatus 18 will allocate the uncontrolled wireless bandwidth resources 23 of the wireless bandwidth resources 2 to the communication apparatus 11 and the BS 13 for data transmission. It should be noted that the wireless bandwidth resources 2 may be allocated according to time (i.e., time division multiplexing), frequency bands (frequency division multiplexing) or a combination of time and frequency bands; people of ordinary skill in the art may readily appreciate how the wireless bandwidth resources 2 are allocated by the server apparatus 18, so this will not be further described herein.

Meanwhile, to reduce interference of the uplinks (ULs) and the downlinks (DLs) of the femtocell BSs to the macro BSs, wireless bandwidth resources partially overlapped or not overlapped at all with those of the macro BSs will be used for femtocell BSs located within wireless communication coverage of the macro BSs. Thus, interference from the femtocell BSs to the macro BSs would be prevented. In the mean time, as the femtocell BSs use wireless bandwidth resources partially overlapped or not overlapped at all with those of the macro BSs, interference among the femtocell BSs can be dispersed according to the frequency band reuse parameters in a random frequency hopping manner.

When the transmit module 183 of the server apparatus 18 transmits the mode transformation message 180 to the communication apparatus 11 and the BS 13, the communication apparatus 11 and the BS 13 will be switched from the controlled mode to the uncontrolled mode, individually. Message transmission of the wireless communication system 1 will be illustrated as shown in FIG. 1F. When the first mobile apparatus 15, the second mobile apparatus 17 and the third mobile apparatus 19 prepare to transmit a first datum 151, a second datum 171 and a third datum 191, respectively, the first mobile apparatus 15, the second mobile apparatus 17 and the third mobile apparatus 19 will request one or a plurality of sub-blocks of the uncontrolled wireless bandwidth resources 23 of the wireless bandwidth resources 2 of the wireless communication system 1 according to sizes of the data to be transmitted from the communication apparatus 11 or the BS 13 to which they are wirelessly connected, respectively.

For example, when the process module 153 of the first mobile apparatus 15 prepares to transmit the first datum 151, it firstly determines and confirms that the wireless communication system 1 is in the uncontrolled mode. Then, the transmit module 155 of the first mobile apparatus 15 transmits a first request message (RM) 150 to the communication apparatus 11 according to the size of the first datum 151. More specifically, as shown in FIG. 1G, the uncontrolled wireless bandwidth resources 23 described in this embodiment comprises a plurality of sub-blocks 239, 240a-240h, 241a-241h, 242a-242h, 243a-243h, and the first request message 150 will be transmitted via one of the blocks 239.

The first request message 150 comprises one or more sequences which correspond to sub-blocks 240a-240h, 241a-241h, 242a-242h, 243a-243h of the uncontrolled wireless bandwidth resources 23 in the wireless bandwidth resources 2 of the wireless communication system 1, respectively. The sequences would be fully or part orthogonal (i.e. time orthogonal, frequency band orthogonal or code orthogonal). Beside, more than one sequence could be corresponded to a same sub-block (e.g. sub-block 240c). More specifically, if the first request message 150 requests the resource of the sub-block 240c, it could choose one of the sequences corresponding to the sub-block 240c to be a request message requesting the sub-block 240c. The way to choice one of the sequences could be a random choice manner or other choose manners. In this example embodiment, the first mobile apparatus 15 will, according to the sequences (e.g., sb_3(1), sb_5(1), sb_8(1), sb_10(1)) comprised in the first request message 150 it transmits, request corresponding sub-blocks of the uncontrolled wireless bandwidth resources 23 in the wireless bandwidth resources 2 of the wireless communication system 1 for use to transmit the first datum 151.

Similarly, when the process module 173 of the second mobile apparatus 17 prepares to transmit the second datum 171, it firstly determines and confirms that the wireless communication system 1 is in the uncontrolled mode. Then, the transmit module 175 of the second mobile apparatus 17 transmits a second request message 170 to the BS 13 according to the size of the second datum 171. Similarly, the second request message 170 will also be transmitted through one of the aforesaid sub-blocks 239.

The second request message 170 also comprises one or more sequences which correspond to sub-blocks of the uncontrolled wireless bandwidth resources 23 in the wireless bandwidth resources 2 of the wireless communication system 1, respectively. In this embodiment, the second mobile apparatus 17 will, according to the sequences (e.g., sb_1(2), sb_2(2), sb_3(2)) comprised in the second request message 170 it transmits, request corresponding sub-blocks of the uncontrolled wireless bandwidth resources 23 in the wireless bandwidth resources 2 of the wireless communication system 1 for use to transmit the second datum 171.

Also similarly, when the process module 193 of the third mobile apparatus 19 prepares to transmit the third datum 191, it firstly determines and confirms that the wireless communication system 1 is in the uncontrolled mode. Then, the transmit module 195 of the third mobile apparatus 19 transmits a third request message 190 to the communication apparatus 11 according to the size of the third datum 191. Similarly, the third request message 190 will also be transmitted through one of the aforesaid sub-blocks 239.

More specifically, the third request message 190 also comprises one or more sequences which correspond to sub-blocks of the uncontrolled wireless bandwidth resources 23 in the wireless bandwidth resources 2 of the wireless communication system 1 respectively. In this example embodiment, the third mobile apparatus 19 will, according to the sequences (e.g., sb_1(3), sb_8(3)) comprised in the third request message 190 it transmits, request corresponding sub-blocks of the uncontrolled wireless bandwidth resources 23 in the wireless bandwidth resources 2 of the wireless communication system 1 for use to transmit the third datum 191.

It should be noted that the first mobile apparatus 15 is also located within the second wireless communication coverage 12 of the BS 13 and the second mobile apparatus 17 is also located within the first wireless communication coverage 10 of the communication apparatus 11, so the first request message 150 transmitted by the first mobile apparatus 15 will also be received by the BS 13 besides the communication apparatus 11; and likewise, the second request message 170 transmitted by the second mobile apparatus 17 will also be received by communication apparatus 11 the besides the BS 13.

Upon the receiving module 111 of the communication apparatus 11 receiving the first request message 150, the second request message 170 and the third request message 190, the process module 113 determines whether the first request message 150 comprising the sequences (i.e., sb_3(1), sb_5(1), sb_8(1), sb_10(1)), the second request message 170 comprising the sequences (i.e., sb_1(2), sb_2(2), sb_3(2)) and the third request message 190 comprising the sequences (i.e., sb_1(3), sb_8(3)) share an identical sequence.

In this example embodiment, the sequences sb_3(1) comprised in the first request message 150 and the sequence sb_3(2) comprised in the second request message 170 are identical to a same sub-block 240a, the sequences sb_8(1) comprised in the first request message 150 and the sequence sb_8(3) comprised in the third request message 190 are identical to a same sub-block 240b, and the sequence sb_1(2) comprised in the second request message 170 and the sequence sb_1(3) comprised in the third request message 190 are identical to a same sub-block 240g. Accordingly, the process module 113 of the communication apparatus 11 will determine that collisions will occur to the sub-block 240a corresponding to the sequences sb_3(1) and sb_3(2), to the sub-block 240b corresponding to the sequences sb_8(1) and sb_8(3), and to the sub-block 240g corresponding to the sequences sb_1(2) and sb_1(3). On the hand, sub-blocks corresponding to other sequences can be used to transmit datum without collision.

Then, the transmit module 115 of the communication apparatus 11 transmits a collision message 110 comprising sequences to which a collision will occur (i.e., the sequences sb_1(2), sb_1(3), sb_3(1), sb_3(2), sb_8(1), sb_8(3)) and a grant message (GM) 112 comprising sequences that can be used for data transmission (i.e., the sequences sb_2(2), sb_5(1), sb_10(1)) to the first mobile apparatus 15 and the third mobile apparatus 19 to which it is wireless connectedly. Meanwhile, in the same manner, the BS 13 will also transmit a collision message 130 comprising sequences to which a collision will occur (i.e., the sequences sb_3(1), sb_3(2)) and a grant message 112 comprising sequences that can be used for data transmission (i.e., the sequences sb_1(2), sb_2(2), sb_5(1), sb_8(1), sb_10(1)) to the second mobile apparatus 17 to which it is wirelessly connected to.

The ways to transmit the collision messages and grant messages can be executed by echoing all the sequences which are received by the transmit modules. For example, the transmit module 115 of the communication apparatus 11 could echo all the received sequences (i.e. sb_1(2), sb_1(3), sb_2(2), sb_3(1), sb_3(2), sb_5(1), sb_8(1), sb_8(3), sb_10(1)). When more than two sequences are identical to a same sub-block, the mobile apparatus determines that a collision will occur. On the other hand, when a sequence and the sequence transmitted previously are identical to a same sub-block, the mobile apparatus determines that a datum can be transmitted.

It should be noted that the first mobile apparatus 15 is also located within the second wireless communication coverage 12 of the BS 13 and the second mobile apparatus 17 is also located within the first wireless communication coverage 10 of the communication apparatus 11, so the collision message 130 and the grant message 132 transmitted by the BS 13 will also be received by the first mobile apparatus 15; and likewise, the collision message 110 and the grant message 112 transmitted by the communication apparatus 11 will also be received by the second mobile apparatus 17.

After the receive module 151 of the first mobile apparatus 15 receives the collision message 110 and the grant message 112 transmitted by the communication apparatus 11 as well as the collision message 130 and the grant message 132 transmitted by the BS 13, the process module 153 of the first mobile apparatus 15 will, according to the sequences sb_3(1), sb_5(1), sb_8(1), sb_10(1) comprised in the first request message 150 it previously transmitted, the sequences sb_1(2), sb_1(3), sb_3(1), sb_3(2), sb_8(1), sb_8(3) comprised in the collision message 110 and the sequence sb_3(1), sb_3(2) comprised in the collision message 130, determines that only the sub-blocks corresponding to the sequences sb_5(1) sb_10(1) can be used to transmit the first datum 151 to the communication apparatus 11. Then, the transmit module 155 of the first mobile apparatus 15 transmits the first datum 151 on sub-blocks of the uncontrolled wireless bandwidth resources 23 in the wireless bandwidth resources 2 corresponding to the sequences sb_5(1) sb_10(1), and the process module 153 of the first mobile apparatus 15 ceases to transmit the first datum 151 on sub-blocks 240a, 240b of the uncontrolled wireless bandwidth resources 23 in the wireless bandwidth resources 2 corresponding to the sequences sb_3(1) sb_8(1).

Similarly, after the receive module 171 of the second mobile apparatus 17 receives the collision message 130 and the grant message 132 transmitted by the BS 13 as well as the collision message 110 and the grant message 112 transmitted by the communication apparatus 11, the process module 173 of the second mobile apparatus 17 will, according to the sequences sb_1(2), sb_2(2), sb_3(2) comprised in the second request message 170 it previously transmitted, the sequence sb_3(1), sb_3(2) comprised in the collision message 130 and the sequences sb_1(2), sb_1(3), sb_3(1), sb_3(2), sb_8(1), sb_8(3) comprised in the collision message 110, determines that only the sub-block corresponding to the sequences sb_2(2) can be used to transmit the second datum 171 to the BS 13. Then, the transmit module 175 of the second mobile apparatus 17 transmits the second datum 171 on the sub-blocks of the uncontrolled wireless bandwidth resources 23 in the wireless bandwidth resources 2 corresponding to the sequence sb_2(2), and the process module 173 of the second mobile apparatus 17 ceases to transmit the second datum 171 on the sub-blocks 240g, 240a of the uncontrolled wireless bandwidth resources 23 in the wireless bandwidth resources 2 corresponding to the sequences sb_1(2) sb_3(2).

Also similarly, after the receive module 191 of the third mobile apparatus 19 receives the collision message 110 and the grant message 112 transmitted by the communication apparatus 11, the process module 193 of the third mobile apparatus 19 will, according to the sequences sb_1(3), sb_8(3) comprised in the third request message 190 it previously transmitted and the sequences sb_1(2), sb_1(3), sb_3(1), sb_3(2), sb_8(1), sb_8(3) comprised in the collision message 110, determines that currently no sub-block corresponding to the sequence can be used to transmit the third datum 191 to the communication apparatus 11. Then, the process module 193 of the third mobile apparatus 19 ceases to transmit and temporarily stores the third datum 191 to wait for sub-blocks of the uncontrolled wireless bandwidth resources 23 in the wireless bandwidth resources 2 that can be used to transmit the third datum 191.

It should be noted that when the first datum 151, the second datum 171 and the third datum 191 is transmitted by the first mobile apparatus 15, the second mobile apparatus 17 and the third mobile apparatus 19 respectively, identification (ID) headers will be transmitted, by use of fixed modulation and encoding schemes, at fixed positions of sub-blocks of the uncontrolled wireless bandwidth resources 23 in the wireless bandwidth resources 2 allocated to them. The ID headers respectively comprise: identities of the first mobile apparatus 15, the second mobile apparatus 17 and the third mobile apparatus 19; BSs to which the first mobile apparatus 15, the second mobile apparatus 17 and the third mobile apparatus 19 are wirelessly connected; the modulation schemes, encoding schemes and serial numbers used by the first datum 151, the second datum 171 and the third datum 191; and other relevant information.

Meanwhile, the first mobile apparatus 15, the second mobile apparatus 17 and the third mobile apparatus 19 are not merely limited to determining whether the first datum 151, the second datum 171 and the third datum 191 can be transmitted according to the collision sequences 110, 130 transmitted by the communication apparatus 11 and the BS 13; rather, how the first mobile apparatus 15, the second mobile apparatus 17 and the third mobile apparatus 19 determine whether the first datum 151, the second datum 171 and the third datum 191 can be transmitted according to the grant messages 112, 133 transmitted by the communication apparatus 11 and the BS 13 may be readily understood by people of ordinary skill in the art upon reviewing the above description and, thus, will not be further described herein.

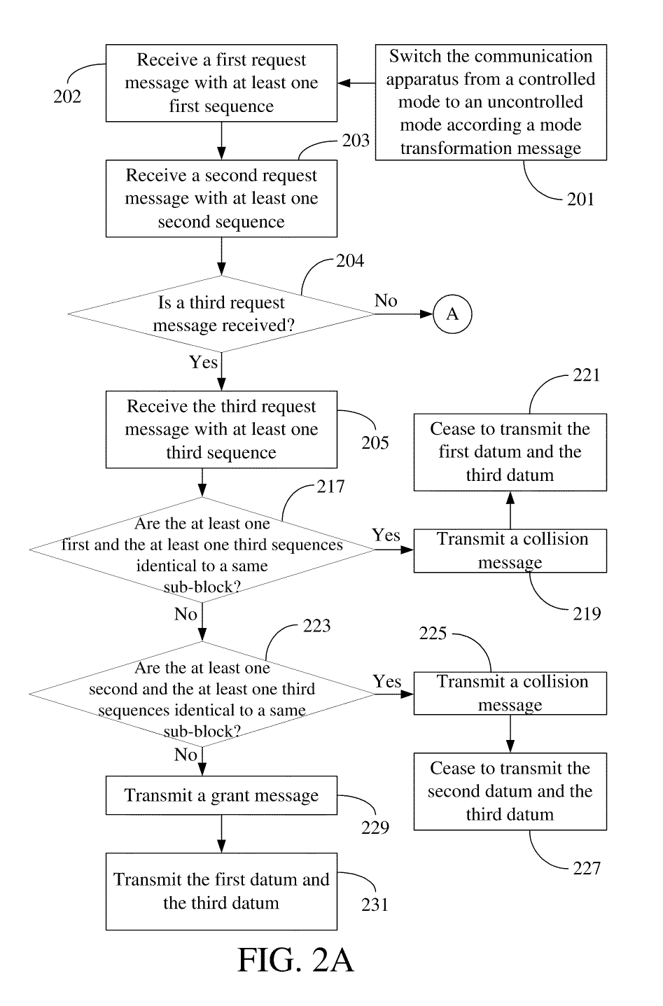

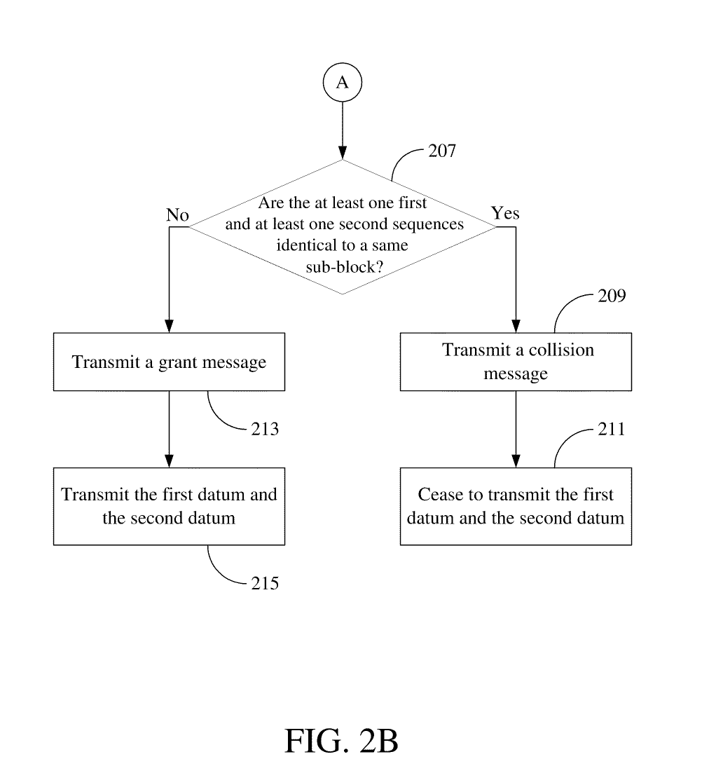

FIGS. 2A-2B show a second example embodiment of the present invention, which is a communication method for a wireless communication system. The communication method of the present invention may be used, for example, for the communication apparatus and/or BS of the wireless communication system described above, e.g., the communication apparatus 11 described in the first embodiment. The wireless communication system comprises a server apparatus, a BS and a plurality of mobile apparatuses. The mobile apparatuses comprise a first mobile apparatus, a second mobile apparatus and a third mobile apparatus. The server apparatus is electrically connected to the communication apparatus and the BS, individually. The first mobile apparatus with a first datum is wirelessly connected with the communication apparatus, the second mobile apparatus with a second datum is wirelessly connected with the BS, and the third mobile apparatus with a third datum is wirelessly connected with the communication apparatus.

In particular, the communication method of the second example embodiment may be implemented by a computer program product which, when being loaded into the communication apparatus via a computer and a plurality of codes contained therein is executed, can accomplish the communication method of the present invention. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

Firstly, step 201 is executed to enable the process module of the communication apparatus to switch the communication apparatus from a controlled mode to an uncontrolled mode according a mode transformation message. Then, step 202 is executed to enable the receive module of the communication apparatus to receive a first request message with at least one first sequence transmitted by the first mobile apparatus. Next, step 203 is executed to enable the receive module of the communication apparatus to receive a second request message with at least one second sequence transmitted by the second mobile apparatus. Then step 204 is executed to determine whether to receive a third request message.

In step 204, if the third request message is not received, step 207 is executed to enable the process module of the communication apparatus to determine whether at least one first sequence and at least one second sequence are identical to a same sub-block. If the at least one first sequence and the at least one second sequence are identical to the same sub-block, step 209 is executed to enable the transmit module of the communication apparatus to transmit a collision message. Next, step 211 is executed to enable the first mobile apparatus and the second mobile apparatus to cease to transmit the first datum and the second datum according to the collision message transmitted in step 209.

Otherwise, if the at least one first sequence and the at least one second sequence are not identical to the same sub-block, step 213 is executed to enable the transmit module of the communication apparatus to transmit a grant message. Next, step 215 is executed to enable the first mobile apparatus and the second mobile apparatus to transmit the first datum and the second datum according to the grant message transmitted in step 213.

On the other hand, if the third request message is determined to be received in step 204, then step 205 is executed to enable the receive module of the communication apparatus to receive the third request message with at least one third sequence transmitted by the third mobile apparatus. Subsequently, step 217 is executed to enable the process module of the communication apparatus to determine whether the at least one first sequence and the at least one third sequence are identical to a same sub-block. If the at least one first sequence and the at least one third sequence are identical to the same sub-block, step 219 is executed to enable the transmit module of the communication apparatus to transmit a collision message. Next, step 221 is executed to enable the first mobile apparatus and the third mobile apparatus to cease to transmit the first datum and the third datum according to the collision message transmitted in step 219.

Otherwise, if the at least one first sequence and the at least one third sequence are not identical to the same sub-block, step 223 is executed to enable the process module of the communication apparatus to determine whether the at least one second sequence and at least one third sequence are identical to a same sub-block. If the at least one second sequence and the at least one third sequence are identical to the same sub-block, step 225 is executed to enable the transmit module of the communication apparatus to transmit a collision message. Next, step 227 is executed to enable the second mobile apparatus and the third mobile apparatus to cease to transmit the second datum and the third datum according to the collision message transmitted in step 225.

Otherwise, if the at least one second sequence and the at least one third sequence are not identical to the same sub-block, step 229 is executed to enable the transmit module of the communication apparatus to transmit a grant message. Finally, step 231 is executed to enable the first mobile apparatus and the third mobile apparatus to transmit the first datum and the third datum according to the grant message transmitted in step 229.

In addition to the aforesaid steps, the communication method of certain embodiments of the present invention can also execute the operations and functions of the communication apparatus set forth in the first embodiment. How the communication method executes these operations and functions will be readily appreciated by those of ordinary skill in the art based on the explanation of the first embodiment, and thus will not be further described herein.

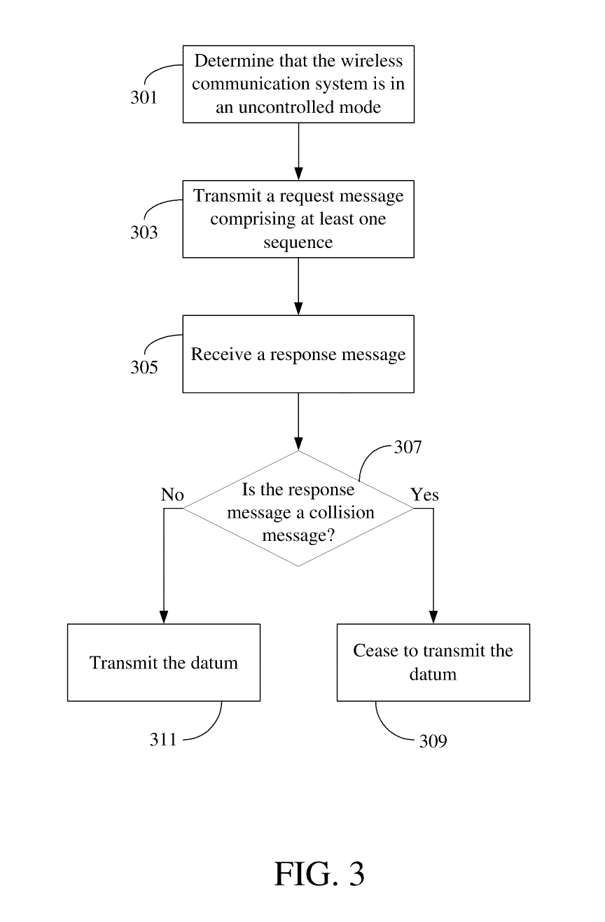

FIG. 3 shows a third example embodiment of the present invention, which is a communication method for a wireless communication system. The communication method may be used for the mobile apparatus of the aforesaid wireless communication system, e.g., the mobile apparatuses 15, 17, 19 described in the first embodiment. The wireless communication system further comprises a communication apparatus and a BS. The mobile apparatus with a datum is wirelessly connected to the BS.

In particular, the communication method of the third example embodiment may be implemented by a computer program product which, when being loaded into the mobile apparatus via a computer and a plurality of codes contained therein is executed, can accomplish the communication method. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

Firstly, step 301 is executed to enable the process module of the mobile apparatus to determine that the wireless communication system is in an uncontrolled mode. Then, step 303 is executed to enable the transmit module of the mobile apparatus to transmit a request message comprising at least one sequence. Next, step 305 is executed to enable the receive module of the mobile apparatus to receive a response message transmitted by the communication apparatus.

Afterwards, step 307 is executed to enable the process module of the mobile apparatus to determine whether the response message is a collision message. If yes, then step 309 is executed to enable the process module of the mobile apparatus to cease to transmit the datum. Otherwise, if it is determined in step 307 that the response message is not a collision message (i.e., the response message is a grant message), then step 311 is executed to enable the transmit module of the mobile apparatus to transmit the datum.

In addition to the aforesaid steps, the communication method can also execute the operations and functions of the mobile apparatus set forth in the first embodiment. How the communication method executes these operations and functions will be readily appreciated by those of ordinary skill in the art based on the explanation of the first embodiment, and thus will not be further described herein.

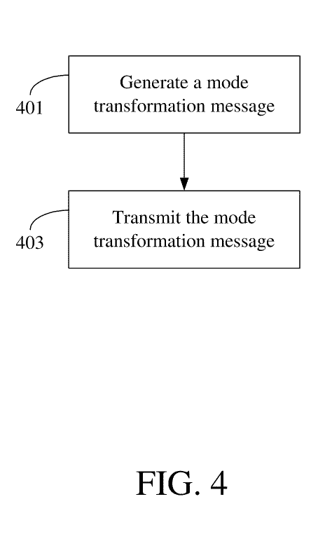

FIG. 4 shows a fourth example embodiment of the present invention, which is a server method for a wireless communication system. The server method may be used for the server apparatus of the aforesaid wireless communication system, e.g., the server apparatuses 18 described in the first example embodiment. The wireless communication system further comprises a communication apparatus and a BS. The server apparatus is wirelessly connected to the communication apparatus and the BS, individually.

In particular, the server method of the fourth example embodiment may be implemented by a computer program product which, when being loaded into the server apparatus via a computer and a plurality of codes contained therein is executed. This computer program product may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

Firstly, step 401 is executed to enable a process module of the server apparatus to generate a mode transformation message according to a usage amount of the wireless bandwidth resources. Then, step 403 is executed to enable a transmit module of the server apparatus to transmit the mode transformation message, so that the communication apparatus and the BS will be switched from the controlled mode to the uncontrolled mode according to the mode transformation message.

In addition to the aforesaid steps, the server method can also execute the operations and functions of the server apparatus set forth in the first example embodiment. How the server method executes these operations and functions will be readily appreciated by those of ordinary skill in the art based on the explanation of the first embodiment, and thus will not be further described herein.

The communication apparatus, the communication method and the computer program product thereof are able to allocate wireless bandwidth resources of the wireless communication system according to request messages from individual mobile apparatuses, and reallocate the wireless bandwidth resources in consideration of a potential conflict, thereby mitigating signal interference among the BSs in the wireless communication system. In this way, the problem that two kinds of communication systems interfere with each other's signals when BSs have a too close distance or a too high density can be addressed without modifying the existing hardware architecture of the wireless communication system.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A communication apparatus for a wireless communication system, the wireless communication system comprising a server apparatus, a base station (BS) and a plurality of mobile apparatuses, the mobile apparatuses comprising a first mobile apparatus with a first datum and a second mobile apparatus with a second datum, the server apparatus being electrically connected to the communication apparatus and the BS, the first mobile apparatus being wirelessly connected to the communication apparatus, the second mobile apparatus being wirelessly connected to the BS, and both the first and second mobile apparatuses being located within a wireless communication coverage of the communication apparatus and a wireless communication coverage of the BS, the communication apparatus comprising:
a receive module being configured to receive a mode transformation message, wherein the mode transformation message is transmitted by the server apparatus according to a usage amount of wireless bandwidth resources of the wireless communication system;
a process module being configured to switch the communication apparatus from a controlled mode to an uncontrolled mode according to the mode transformation message; and
a transmit module;
wherein the receive module is further configured to receive a first request message transmitted by the first mobile apparatus with at least one first sequence and to receive a second request message transmitted by the second mobile apparatus with at least one second sequence, the process module is configured to determine whether the at least one first sequence and the at least one second sequence are identical to a same sub-block, and the transmit module is configured to transmit a response message according to the determination result of the process module; and
wherein the first mobile apparatus determines whether to transmit the first datum according to the response message.

2. The communication apparatus as claimed in claim 1, wherein when the process module determines that the at least one first sequence and the at least one second sequence are identical to the same sub-block, the transmit module transmits a collision message so that the first mobile apparatus ceases to transmit the first datum according to the collision message, the second mobile apparatus ceases to transmit the second datum according to the collision message, and the response message is the collision message.

3. The communication apparatus as claimed in claim 1, wherein when the process module determines that the at least one first sequence and the at least one second sequence are not identical to the same sub-block, the transmit module transmits a grant message so that the first mobile apparatus transmits the first datum to the communication apparatus according to the grant message, the second mobile apparatus transmits the second datum to the communication apparatus according to the grant message, and the response message is the grant message.

4. The communication apparatus as claimed in claim 1, wherein the mobile apparatuses further comprises a third mobile apparatus with a third datum, the third mobile apparatus is wirelessly connected to the communication apparatus, the receive module is configured to receive a third request message transmitted by the third mobile apparatus with at least one third sequence, the process module is further configured to determine whether the at least one first sequence, the at least one second sequence and the at least one third sequence are identical to a same sub-block, and the transmit module is configured to transmit the response message according to the determination result of the process module so that the third mobile apparatus determines whether to transmit the third datum according to the response message.

5. The communication apparatus as claimed in claim 4, wherein when the process module determines that the at least one first sequence and the at least one third sequence are identical to the same sub-block, the transmit module transmits a collision message so that the first mobile apparatus ceases to transmit the first datum according to the collision message, and so that the third mobile apparatus ceases transmit the third datum according to the collision message, wherein the response message is the collision message.

6. The communication apparatus as claimed in claim 4, wherein when the process module determines that the at least one second sequence and the at least one third sequence are identical to the same sub-block, the transmit module transmits a collision message so that the first mobile apparatus ceases transmit the first datum according to the collision message, the third mobile apparatus ceases transmit the third datum according to the collision message, and the response message is the collision message.

7. The communication apparatus as claimed in claim 4, wherein when the process module determines that the at least one third sequence and the at least one first sequence are not identical to the same sub-block, and the at least one third sequence and the at least one second sequence are not identical to the same sub-block, the transmit module transmits a grant message so that the first mobile apparatus transmits the first datum to the communication apparatus according to the grant message, so that the second mobile apparatus transmits the second datum to the communication apparatus according to the grant message, and so that the third mobile apparatus transmits the third datum to the communication apparatus according to the grant message, wherein the response message is the grant message.

8. A communication method for a wireless communication system, the wireless communication system comprising a server apparatus, a base station (BS), a communication apparatus and a plurality of mobile apparatuses, the mobile apparatuses comprising a first mobile apparatus with a first datum and a second mobile apparatus with a second datum, the server apparatus being electrically connected to the communication apparatus and the BS, the first mobile apparatus being wirelessly connected to the communication apparatus, the second mobile apparatus being wirelessly connected to the BS, and both the first and second mobile apparatuses being located within a wireless communication coverage of the communication apparatus and a wireless communication coverage of the BS, the communication method comprising the steps of:
enabling a receive module to receive a mode transformation message, wherein the mode transformation message is transmitted by the server apparatus according to a usage amount of wireless bandwidth resources of the wireless communication system;
enabling a process module to switch the communication apparatus from a controlled mode to an uncontrolled mode according to the mode transformation message;
enabling the receive module to receive a first request message transmitted by the first mobile apparatus, wherein the first request message comprises at least one first sequence;
enabling the receive module to receive a second request message transmitted by the second mobile apparatus, wherein the second request message comprises at least one second sequence;
enabling the process module to determine whether the at least one first sequence and the at least one second sequence are identical to a same sub-block; and
enabling a transmit module to transmit a response message according to the determination result of the process module;
wherein the first mobile apparatus determines whether to transmit the first datum according to the response message.

9. The communication method as claimed in claim 8, wherein the step of transmitting the response message further comprises the step of:
when the at least one first sequence and the at least one second sequence are identical to the same sub-block, enabling the transmit module to transmit a collision message;
wherein the first mobile apparatus ceases to transmit the first datum according to the collision message; and
wherein the second mobile apparatus ceases to transmit the second datum according to the collision message, and the response message is the collision message.

10. The communication method as claimed in claim 8, wherein the step of transmitting the response message further comprises the step of:
when the at least one first sequence and the at least one second sequence are not identical to the same sub-block, enabling the transmit module to transmit a grant message;
wherein the first mobile apparatus transmits the first datum to the communication apparatus according to the grant message; and
wherein the second mobile apparatus transmits the second datum to the communication apparatus according to the grant message, and the response message is the grant message.

11. The communication method as claimed in claim 8, wherein the mobile apparatuses further comprises a third mobile apparatus with a third datum, the third mobile apparatus is wirelessly connected to the communication, the communication method further comprises the steps of:
enabling the receive module to receive a third request message transmitted by the third mobile apparatus, wherein the third request message comprises at least one third sequence; and
enabling the process module to determine whether the at least one first sequence, the at least one second sequence and the at least one third sequence are identical to a same sub-block;
wherein the transmit module is configured to transmit the response message according to the determination result of the process module, and the third mobile apparatus determines whether to transmit the third datum according to the response message.

12. The communication method as claimed in claim 11, wherein the step of transmitting the response message further comprises the step of:
when the at least one first sequence and the at least one third sequence are identical to the same sub-block, enabling the transmit module to transmit a collision message;
wherein the first mobile apparatus ceases to transmit the first datum according to the collision message; and
wherein the third mobile apparatus ceases to transmit the third datum according to the collision message, and the response message is the collision message.

13. The communication method as claimed in claim 11, wherein the step of transmitting the response message further comprises the step of:
when the at least one second sequence and the at least one third sequence are identical to the same sub-block, enabling the transmit module to transmit a collision message;
wherein the first MS mobile apparatus ceases to transmit the first datum according to the collision message; and
wherein the third mobile apparatus ceases to transmit the third datum according to the collision message, and the response message is the collision message.

14. The communication method as claimed in claim 11, wherein the step of transmitting the response message further comprises the step of:
when the at least one third sequence and the at least one first sequence are not identical to the same sub-block, and the at least one third sequence and the at least one second sequence are not identical to the same sub-block, enabling the transmit module to transmit a grant message;
wherein the first mobile apparatus transmits the first datum to the communication apparatus according to the grant message;
wherein the second mobile apparatus transmits the second datum to the communication apparatus according to the grant message; and
wherein the third mobile apparatus transmits the third datum to the communication apparatus according to the grant message, and the response message is the grant message.

15. A computer program product, comprising a tangible machine-readable medium having executable codes to cause an apparatus to perform a communication method for a wireless communication system, the wireless communication system comprising a server apparatus, a base station (BS), a communication apparatus and a plurality of mobile apparatuses, the mobile apparatuses comprising a first mobile apparatus with a first datum and a second mobile apparatus with a second datum, the server apparatus being electrically connected to the communication apparatus and the BS, the first mobile apparatus being wirelessly connected to the communication apparatus, the second mobile apparatus being wirelessly connected to the BS, and both the first and second mobile apparatuses being located within a wireless communication coverage of the communication and a wireless communication coverage of the BS, the executable codes comprising:
a code A for enabling a receive module to receive a mode transformation message, wherein the mode transformation message is transmitted by the server apparatus according to a usage amount of wireless bandwidth resources of the wireless communication system;
a code B for enabling a process module to switch the communication apparatus from a controlled mode to an uncontrolled mode according to the mode transformation message;
a code C for enabling the receive module to receive a first request message transmitted by the first mobile apparatus, wherein the first request message comprises at least one first sequence;
a code D for enabling the receive module to receive a second request message transmitted by the second mobile apparatus, wherein the second request message comprises at least one second sequence;
a code E for enabling the process module to determine whether the at least one first sequence and the at least one second sequence are identical to a same sub-block each other; and
a code F for enabling a transmit module to transmit a response message according to the determination result of the process module;
wherein the first mobile apparatus determine whether to transmit the first datum according to the response message.

16. The computer program product as claimed in claim 15, wherein the code F further comprises:
a code F1 for enabling the transmit module to transmit a collision message when the at least one first sequence and the at least one second sequence are identical to the same sub-block;
wherein the first mobile apparatus ceases to transmit the first datum according to the collision message; and
wherein the second mobile apparatus ceases to transmit the second datum according to the collision message, and the response message is the collision message.

17. The computer program product as claimed in claim 15, wherein the code F further comprises:
a code F1 for enabling the transmit module to transmit a grant message when the at least one first sequence and the at least one second sequence are not identical to the same sub-block;
wherein the first mobile apparatus transmits the first datum to the communication apparatus according to the grant message; and
wherein the second mobile apparatus transmits the second datum to the communication apparatus according to the grant message, and the response message is the grant message.

18. The computer program product as claimed in claim 15, wherein the mobile apparatuses further comprises a third mobile apparatus with a third datum, the third mobile apparatus is wirelessly connected to the communication apparatus, the executable codes further comprises:
a code G for enabling the receive module to receive a third request message transmitted by the third mobile apparatus, wherein the third request message comprises at least one third sequence; and
a code H for enabling the process module to determine whether the at least one first sequence, the at least one second sequence and the at least one third sequence are identical to a same sub-block;
wherein the transmit module is configured to transmit the response message according to the determination result of the process module, and the third mobile apparatus determines whether to transmit the third datum according to the response message.

19. The computer program product as claimed in claim 18, wherein the code F further comprises:
a code F1 for enabling the transmit module to transmit a collision message when the at least one first sequence and the at least one third sequence are identical to the same sub-block;
wherein the first mobile apparatus ceases to transmit the first datum according to the collision message; and
wherein the third mobile apparatus ceases to transmit the third datum according to the collision message, and the response message is the collision message.

20. The computer program product as claimed in claim 18, wherein the code F further comprises:
a code F1 for enabling the transmit module to transmit a collision message when the at least one second sequence and the at least one third sequence are identical to the same sub-block;
wherein the first mobile apparatus ceases to transmit the first datum according to the collision message; and
wherein the third mobile apparatus ceases to transmit the third datum according to the collision message, and the response message is the collision message.

21. The computer program product as claimed in claim 18, wherein the code F further comprises:
a code F1 for enabling the transmit module to transmit a grant message when the at least one third sequence and the at least one first sequence are not identical to the same sub-block, and the at least one third sequence and the at least one second sequence are not identical to the same sub-block;
wherein the first mobile apparatus transmits the first datum to the communication apparatus according to the grant message;
wherein the second mobile apparatus transmits the second datum to the communication apparatus according to the grant message;
wherein the third mobile apparatus transmits the third datum to the communication apparatus according to the grant message, and the response message is the grant message.
